(19) United States
(12) Patent Application Publication
(10) Pub. No.: US 2012/0102077 A1
(43) Pub. Date: Apr. 26, 2012

(54) METHOD AND APPARATUS TO CONVERT MULTIMEDIA FILE NAME

(75) Inventor: Jeong-hun Lee, Seoul (KR)

(73) Assignee: Samsung Electronics Co., Ltd, Suwon-si (KR)

(21) Appl. No.: 13/222,193

(22) Filed: Aug. 31, 2011

(30) Foreign Application Priority Data
Oct. 21, 2010 (KR) 2010-0102913

(51) Int. Cl. G06F 17/30

(52) U.S. Cl. 707/822; 707/E17.01

(57) ABSTRACT

A method and an apparatus to convert a multimedia file name. The method can include: if a generation time information based file name conversion request for at least one multimedia file stored in a storage medium is received, then listing original files comprising generation time information of the at least one multimedia file stored in the storage medium; analyzing a directory which stores the listed original files to rearrange the original files based on the generation time information of the at least one multimedia file; and converting file names of the rearranged original files into generation time information based file names.

### CROSS-REFERENCE TO RELATED APPLICATIONS

This application claims the benefit under 35 U.S.C. §119 from Korean Patent Application No. 10-2010-0102913, filed on Oct. 21, 2010, in the Korean Intellectual Property Office, the disclosure of which is incorporated herein by reference in its entirety.

### BACKGROUND OF THE INVENTION

1. Field of the Invention

The present general inventive concept generally relates to a method and an apparatus to convert a multimedia file name, and more particularly, to a method and an apparatus to convert a multimedia file name in a multimedia processing apparatus.

2. Description of the Related Art

There are various methods of providing a file name from a multimedia processing apparatus to a user. Among these methods, if a user captures an image in a digital image processing apparatus such as a general digital camera, the digital image processing apparatus provides a file to the user in a format as shown in FIG. 1 based on the Design rule for Camera File system (DCF) protocol, which was created to provide DCF compatibility between storage media.

According to the DCF protocol, as shown in FIG. 1, a DCF directory is formed of three digit numbers and five digit letters, and a DCF file is formed of four digit letters and four digit numbers.

Also, according to the DCF protocol, letters are differently formed according to products, and numbers are formed according to Series and Reset rules that are file number rules.

However, in compliance with the DCF protocol, a file name is generated regardless of a time when a user captures an image, and the user is to check an attribute “Date to be Made” of a folder or an attribute of a file to check a time when the corresponding file has been generated.

Also, even if the user reproduces the file using an image viewer or a video player, the user cannot check the time when the corresponding file has been generated, using the file name.

Also, if the user wants to arrange and store files of captured images by date in a personal storage media, the user is required to separately check capturing times to generate a new folder and store the files in the folder. File names overlap with one another or file names respectively stored in other storage media overlap with one another by mistake, thereby causing inconveniences when storing files.

### SUMMARY OF THE INVENTION

The present general inventive concept provides a method and an apparatus to convert a multimedia file name by which a file name can be provided based on file generation time information.

Additional embodiments of the present general inventive concept will be set forth in part in the description which follows and, in part, will be obvious from the description, or may be learned by practice of the general inventive concept.

The foregoing and/or other features and utilities of the present general inventive concept may be achieved by a method of converting a multimedia file name, the method including: if a generation time information based-file name conversion request for at least one multimedia file stored in a storage medium is received, listing original files including generation time information of the at least one multimedia file stored in the storage medium; analyzing a directory which stores the listed original files to rearrange the original files based on the generation time information of the at least one multimedia file; and converting file names of the rearranged original files into generation time information based-file names.

The listing of the original files may include generating a list of original files comprising the generation time information.

The rearrangement of the original files may include generating a list of rearranged original files based on the generation time information.

The storage medium may be a multimedia processing apparatus which stores the original files or a personal computer (PC) which is connected to the multimedia processing apparatus.

The method may further include comparing capacities of the original files with a residual capacity of the storage medium. If the residual capacity is larger than or equal to the capacities of the original files, the original files including the generation time information of the at least one multimedia file stored in the storage medium may be listed.

The conversion of the file names of the rearranged original files into the generation time information based-file names may include: copying the original files based on the generation time information; and converting the copied original files into the generation time information based file names.

A folder name or a folder structure which stores the generation time information-based file names may be changed by a user.

The generation time information based-file names may include at least one of a year, month, day, time, minute, second, and day of the week information of a generation or change of the original files.

The multimedia file may include at least one of a picture file, a moving picture file, and a music file.

The foregoing and/or other features and utilities of the present general inventive concept may also be achieved by an apparatus to convert a multimedia file name, the apparatus including: a file name conversion request receiver to receive a generation time information based-file name conversion request for at least one multimedia file stored in a storage medium; a file name converter to convert a file name of an original file of the at least one multimedia a file into the generation time information based-file name of the at least one multimedia file according to the generation time information based file name conversion request; and a file name output unit to display the generation time information based-file name converted by the file name converter.

The file name converter may include: an original file list generator to generate a list of original files including the generation time information of the at least one multimedia file stored in the storage medium; and an original file rearrangement list generator to analyze a directory storing the original files to generate a list of rearranged original files based on the generation time information of the at least one multimedia file.

The storage medium may be a multimedia processing apparatus which stores the original files or a PC which is connected to the multimedia processing apparatus.

The file name converter may compare capacities of the original files with a residual capacity of the storage medium, and if the capacities of the original files are larger than or equal to the residual capacity of the storage medium, convert file names of the original files into the generation time information based-file names of the at least one multimedia file stored in the storage medium.

The file name converter may copy the original files based on the generation time information and convert the copied original files into the generation time information based-file names.

A folder name or a folder structure which stores the generation time information based-file names may be changed by a user.

The generation time information based-file names may include at least one of a year, month, day, time, minute, second, and day of the week information of a generation or change of the original files.

The multimedia file may include at least one of a picture file, a moving picture file, and a music file.

As described above, according to various exemplary embodiments, the method and apparatus may provide a user with a file name based on multimedia file generation time information to provide convenience of file management to the user.

The foregoing and/or other features and utilities of the present general inventive concept may also be achieved by a method of rearranging multimedia file names of a multimedia processing apparatus, the method including: copying an original file based on generation time information; and converting a file name of the copied original file into a generation time information based file name.

The foregoing and/or other features and utilities of the present general inventive concept may also be achieved by an apparatus to convert multimedia file names, the apparatus including: a file name converter to convert a file name of an original file of at least one multimedia file stored in a storage medium into a generation time based file name of the at least one multimedia file according to a generation time formation based file name request; and a file name output unit to display the generation time information based file name converted by the file name converter.

The foregoing and/or other features and utilities of the present general inventive concept may also be achieved by a non-transitory computer readable medium to perform a method of converting a multimedia file name, the method including: listing original files comprising generation time information of at least one multimedia file stored in a storage medium if a generation time information based file name conversion request for the at least one multimedia file stored in a storage medium is received; analyzing a directory which stores the listed original files to rearrange the original files based on the generation time information of the at least one multimedia file; and converting file names of the rearranged original files into generation time information based-file names.

### BRIEF DESCRIPTION OF THE DRAWINGS

These and/or other embodiments of the present general inventive concept will become apparent and more readily appreciated from the following description of the embodiments, taken in conjunction with the accompanying drawings of which:

FIG. 1 is a view illustrating files that are provided based on the Design rule for Camera File system (DCF);

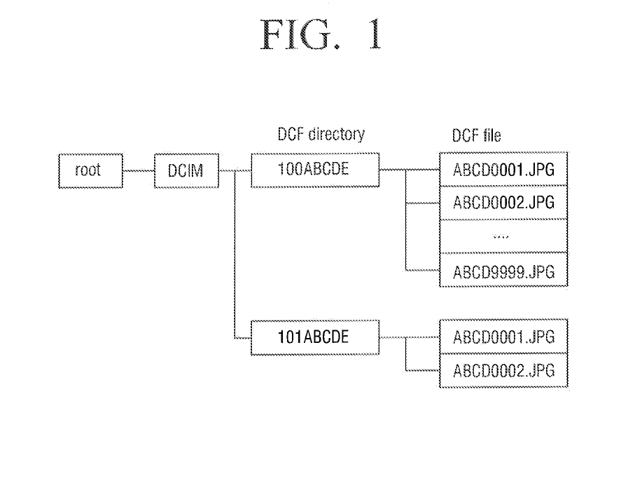

FIG. 2 is a block diagram illustrating an apparatus to convert a multimedia file name according to an exemplary embodiment;

FIG. 3 is a view illustrating a list of original files including generation time information in the apparatus, according to an exemplary embodiment;

FIG. 4 is a view illustrating a list of original files that are rearranged based on generation time information in the apparatus, according to an exemplary embodiment;

FIG. 5 is a view illustrating a process of copying or converting file names of rearranged original files into generation time information based-file names in the apparatus, according to an exemplary embodiment;

FIG. 6 is a view illustrating a process of displaying time generation information based-file names into which rearranged original files are converted in the apparatus, according to an exemplary embodiment; and

FIG. 7 is a flowchart illustrating a method of converting a multimedia file name according to an exemplary embodiment.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

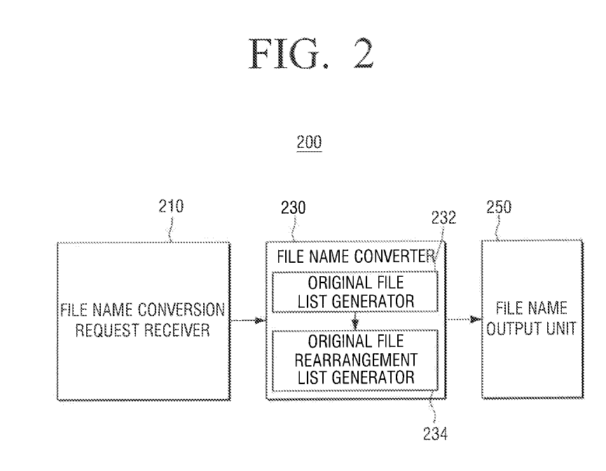

FIG. 2 is a block diagram illustrating an apparatus 200 to convert a multimedia file name according to an exemplary embodiment. As shown in FIG. 2, the apparatus 200 may include a file name conversion request receiver 210, a file name converter 230, and a file name output unit 250.

The file name conversion request receiver 210 receives a generation time information based-file name conversion request for at least one multimedia file stored in a storage medium.

The multimedia file may include at least one of a picture file, a moving picture file, and a music file.

In other words, various types of multimedia files including picture files, moving picture files, and music files may be converted into generation time information based-file names that are based on capturing times of pictures or moving pictures or generation times of music files.

The file name converter 230 converts a file name of an original file of the at least one multimedia file into a generation time based file name of the at least one multimedia file according to the generation time formation based-file name conversion request. As shown in FIG. 2, the file name converter 230 includes an original file list generator 232 and an original file rearrangement list generator 234.

Here, the storage medium may be a multimedia device that stores an original file or a personal computer (PC) that is connected to the multimedia device.

For example, functions of the apparatus may be performed in a multimedia device that stores an original file, such as a digital camera or a digital image processing apparatus. Alternatively, the functions of the apparatus may be automatically executed by software of a PC to which the multimedia device, such as the digital image processing apparatus, is connected.

A storage medium that stores a file corresponding to a file name to be converted may be a storage medium that stores an original file. For example, if an original file is stored in an external memory, a file corresponding to a file name to be converted may be stored in the external memory. If the original file is stored in an internal memory, the file corresponding to the file name to be converted may be stored in the internal memory. If the original file is stored in a PC connected to a multimedia device, a user may select a storage location of the file corresponding to the file name to be converted according to environments of the PC.

According to an exemplary embodiment, the file name converter 230 compares a capacity of the original file with a residual capacity of the storage medium. If the residual capacity is larger than or equal to the capacity of the original file, the file name converter 230 can convert the file name of the original file into the generation time information based-file name of the at least one multimedia file stored in the storage medium.

Here, the file name converter 230 may copy the original file based on the generation time information and convert a file name of the copied original file into the generation time information based file name.

The reason why the file name converter 230 converts the file name of the original file into the generation time information based-file name is to check the residual capacity of the storage medium that stores the original file because the file name converter 230 copies the original file and converts the file name of the copied original file into the generation time information based file name.

In other words, the storage capacity of the file corresponding to the file name to be converted is to be larger than or equal to a total capacity of original files.

The original file list generator 232 generates a list of original files including the generation time information of the at least one multimedia file stored in the storage medium.

For example, the original file list generator 232 may generate a list of original files stored in the storage medium according to the DCF protocol and also list generation time information of the original files in the original files.

The original file rearrangement list generator 234 analyzes a directory that stores the original files to generate a list of original files that are rearranged based on the generation time information of the at least one multimedia file.

In other words, the original file rearrangement list generator 234 may rearrange the list of original files, which are listed along with the generation time information according to the DCF protocol, according to the generation time information, e.g., in a fast generation time order.

The file name output unit 250 displays the generation time information based file name converted by, the file name converter 230.

Here, a folder name or a folder structure that stores the generation time information based file name may be changed by the user.

In other words, the user may differently set the folder name or the folder structure by year or other form of date.

The generation time information based-file name may include at least one of a year, month, day, time, minute, second, and day of the week information of the generation or change of the original file.

In other words, besides the year, month, day, time, minute, and second information at which a file has been generated or changed by an edition, day of the week information, etc., may be added to a file name. Also, the file name may have various structures according to the above-described information.

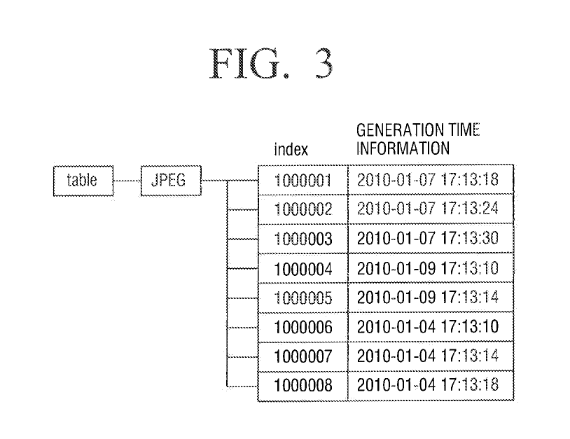

A process of converting a file name based on generation time information will now be described with reference to FIGS. 3 through 5.

FIG. 3 is a view illustrating a list of original files including generation time information in the apparatus, according to an exemplary embodiment.

As shown in FIG. 3, 3 digit numbers of a DCF directory are combined with 4 digit letters of a DCF file to generate a list of original files based on a decimal number 7-digit independent index (index of FIG. 3, listing original files as 7-digit number files). The list of original files includes generation time information.

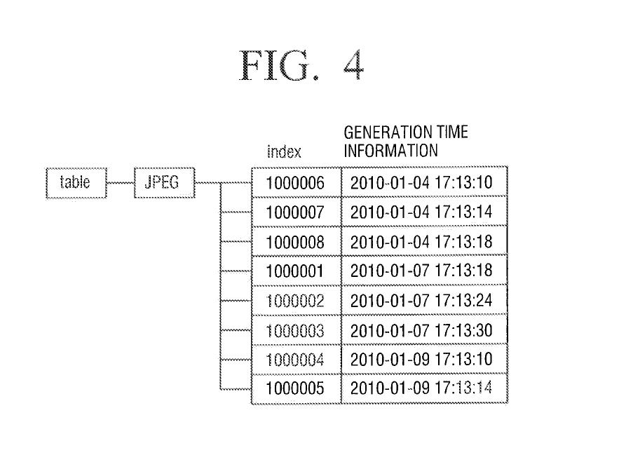

FIG. 4 is a view illustrating a list of the original files that are rearranged based on generation time information in the apparatus, according to an exemplary embodiment.

As shown in FIG. 4, the list of rearranged original files indicates that the list of original files of FIG. 3 is rearranged based the time generation information.

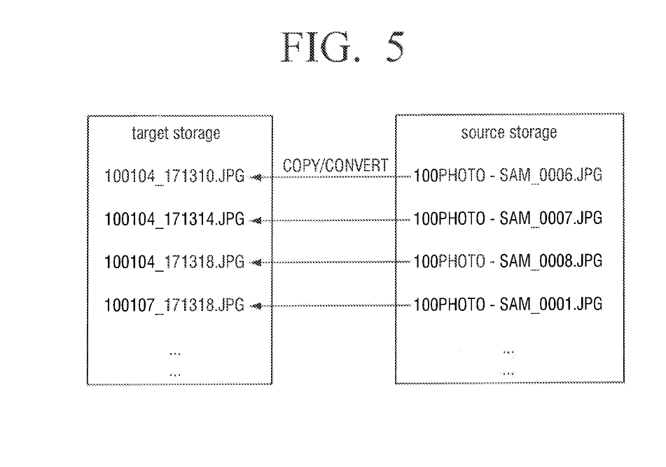

FIG. 5 is a view illustrating a process of coping or converting file names of rearranged original files into generation time information based-file names in the apparatus, according to an exemplary embodiment

As shown in FIG. 5, original files having file names not including generation time information are copied or converted into file names including generation time information through the processes described with reference to FIGS. 3 and 4.

If an original file generated according to the DCF rule is copied, and the copied original file is converted into a file name including generating time information, the original file has DCF compatibility and can be reproduced in another multimedia device. Also, generation time information of a original file corresponding to the converted file name can be easily checked in a corresponding device. If the original file generated according to the DCF rule is directly converted into a file name including generation time information, and the original file does not satisfy the DCF rule, the original file may not be reproduced.

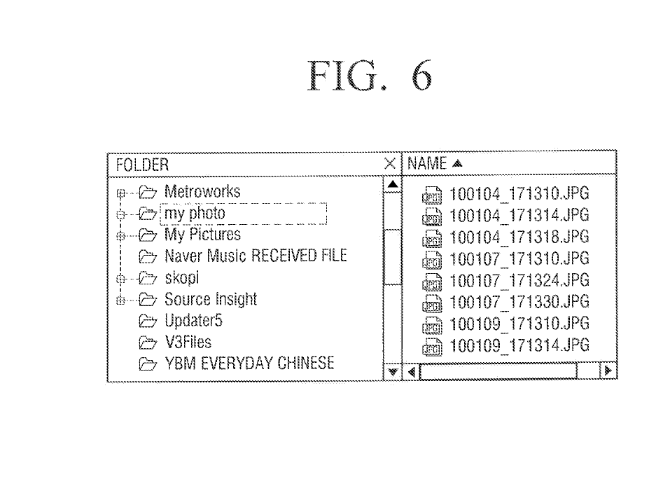

FIG. 6 is a view illustrating a process of displaying file names that are converted into generation time information based-file names in the apparatus, according to an exemplary embodiment.

For example, the file name output unit 250 displays files corresponding to file names including generation time information in a folder “my photo” as shown in FIG. 6. Here, a folder name or a folder structure may be arbitrarily changed by a user.

Accordingly, an apparatus to convert a multimedia file name according to an exemplary embodiment allows a user to check file names that are sorted out according to generation time information of files to provide convenience of file management to the user. Also, the apparatus allows the user to easily check a capturing time, a generation time, or an edit time of a corresponding file using only a file name. In addition, file generation time information may include generation time, minute, and second information of a file, and thus inconvenience caused by overlapping files may be reduced.

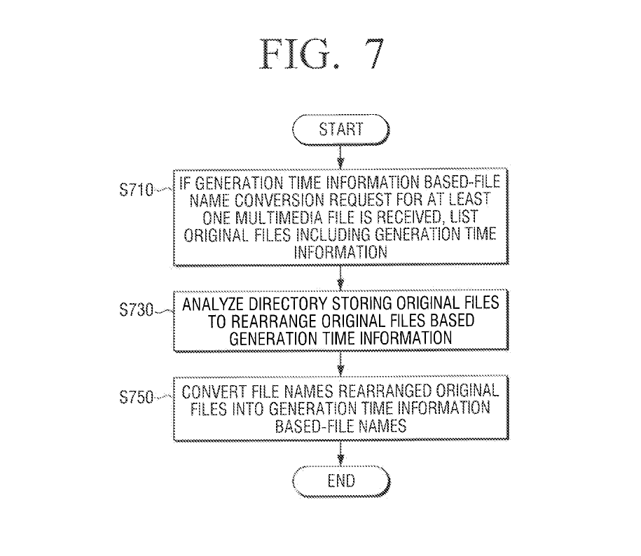

FIG. 7 is a flowchart illustrating a method of converting a multimedia file name according to an exemplary embodiment.

The contents of the method overlapping with the contents of the apparatus will be described in brief.

If a generation time information based-file name request for at least one multimedia file stored in a storage medium is received, original files including generation time information of the at least one multimedia file are listed (operation S710).

The multimedia file may include at least one of a picture file, a moving picture file, and a music file. In other words, various types of multimedia files including picture files, moving picture files, and music files may be converted into generation time information based file names that are based on capturing times of pictures or moving pictures or generation times of music files.

Here, the storage medium may be a multimedia processing apparatus that stores an original file or a PC that is connected to the multimedia processing apparatus.

For example, functions performed in the method according to the present embodiment may be performed in a multimedia device that stores an original file, such as a digital camera or a digital image processing apparatus, or may be automatically executed by software of a PC to which a multimedia device such as a digital image processing apparatus is connected.

According to an exemplary embodiment, the method may further include comparing a capacity of an original file with a residual capacity of a storage medium. If the residual capacity is larger than or equal to the capacity of the original file, original files including generation time information of the at least one multimedia file stored in the storage medium may be listed.

In other words, a storage capacity of a file corresponding to a file name to be converted should be larger than or equal to a total capacity of the original file.

According to an exemplary embodiment, the listing of the original files may include generating a list of original files including generation time information.

For example, in the method according to the present embodiment, a list of original files stored in the storage medium may be generated according to the DCF protocol, and generation time information of the original files may also be listed in the original files.

A directory storing the list of original files is analyzed to rearrange the original files based on the generation time information of the at least one multimedia file (operation S730).

According to an exemplary embodiment, the rearrangement of the original files may include generating a list of rearranged original files based on the generation time information.

In other words, the method may rearrange the list of original files, which are listed along with the generation time information according to the DCF protocol, according to the generation time information, e.g., in a fast generation time order.

File names of the rearranged original files are converted into generation time information based file names (operation S750).

According to an exemplary embodiment, the conversion of the file names of the rearranged original files into the generation time information based file names may include: copying the original files based on the generation time information; and converting the copied original files into the generation time information based file names based on the generation time information.

The reason why the file name of the original file is converted into the generation time information based file name is to check the residual capacity of the storage medium that stores the original file because the original file is copied, and the file name of the copied original file is converted into the generation time information based file name.

Here, a folder name or a folder structure storing the generation time information based file name may be changed by a user.

In other words, the user may differently set the folder name or the folder structure by year or date.

Also, the generation time information based-file name may include at least one of a year, month, day, time, minute, second, and day of the week information of the generation or change of the original file.

In other words, in addition to the year, month, day, time, minute, and second information at which a file has been generated or changed by an edit, day of the week information, etc., may be added to a file name. Also, the file name may have various structures according to the above-described information.

Accordingly, the method of converting the multimedia file name according to an exemplary embodiment may allow the user to check file names sorted out according to generation time information of files to provide convenience of file management to the user. Also, the method may allow the user to easily check a capturing time, a generation time, or an edit time of a corresponding file using only a file name. In addition, the file generation time information may also include generation time, minute, and second information of a file, and thus inconvenience caused by overlapping files may be reduced.

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. A method of converting a multimedia file name, the method comprising:
listing original files comprising generation time information of at least one multimedia file stored in a storage medium if a generation time information based file name conversion request for the at least one multimedia file stored in a storage medium is received;
analyzing a directory which stores the listed original files to rearrange the original files based on the generation time information of the at least one multimedia file; and
converting file names of the rearranged original files into generation time information based-file names.

2. The method as claimed in claim 1, wherein the listing of the original files comprises generating a list of original files comprising the generation time information.

3. The method as claimed in claim 1, wherein the rearrangement of the original files comprises generating a list of rearranged original files based on the generation time information.

4. The method as claimed in claim 1, wherein the storage medium is a multimedia processing apparatus which stores the original files or a personal computer (PC) which is connected to the multimedia processing apparatus.

5. The method as claimed in claim 1, further comprising:
comparing capacities of the original files with a residual capacity of the storage medium,
wherein if the residual capacity is larger than or equal to the capacities of the original files, the original files comprising the generation time information of the at least one multimedia file stored in the storage medium are listed.

6. The method as claimed in claim 1, wherein the conversion of the file names of the rearranged original files into the generation time information based file names comprises:
copying the original files based on the generation time information; and
converting the copied original files into the generation time information based file names.

7. The method as claimed in claim 1, wherein a folder name or a folder structure which stores the generation time information-based file names is changed by a user.

8. The method as claimed in claim 1, wherein the generation time information based file names comprise at least one of a year, month, day, time, minute, second, and day of the week information of a generation or change of the original files.

9. The method as claimed in claim 1, wherein the multimedia file comprises at least one of a picture file, a moving picture file, and a music file.

10. An apparatus to convert a multimedia file name, the apparatus comprising:
a file name conversion request receiver to receive a generation time information based file name conversion request for at least one multimedia file stored in a storage medium;
a file name converter to convert a file name of an original file of the at least one multimedia file into the generation time information based file name of the at least one multimedia file according to the generation time information based file name conversion request; and
a file name output unit to display the generation time information based file name converted by the file name converter.

11. The apparatus as claimed in claim 10, wherein the file name converter comprises:
an original file list generator to generate a list of original flies comprising the generation time information of the at least one multimedia file stored in the storage medium; and
an original file rearrangement list generator to analyze a directory storing the original files to generate a list of rearranged original files based on the generation time information of the at least one multimedia file.

12. The apparatus of claim 10, wherein the storage medium is a multimedia processing apparatus which stores the original files or a PC which is connected to the multimedia processing apparatus.

13. The apparatus of claim 10, wherein the file name converter compares capacities of the original files with a residual capacity of the storage medium, and if the capacities of the original files are larger than or equal to the residual capacity, converts file names of the original files into the generation time information based file names of the at least one multimedia file stored in the storage medium.

14. The apparatus of claim 10, wherein the file name converter copies the original files based on the generation time information and converts the copied original files into the generation time information based file names.

15. The apparatus of claim 10, wherein a folder name or a folder structure which stores the generation time information based-file names is changed by a user.

16. The apparatus of claim 10, wherein the generation time information based file names comprise at least one of a year, month, day, time, minute, second, and day of the week information of a generation or change of the original files.

17. The apparatus of claim 10, wherein the multimedia file comprises at least one of a picture file, a moving picture file, and a music file.

18. A method of rearranging multimedia file names of a multimedia processing apparatus, the method comprising:
copying an original file based on generation time information; and
converting a file name of the copied original file into a generation time information based file name.

19. The method of claim 18, further comprising:
displaying the file names that are converted into generation time information based file names in the apparatus.

20. An apparatus to convert multimedia file names, the apparatus comprising:
a file name converter to convert a file name of an original file of at least one multimedia file stored in a storage medium into a generation time based file name of the at least one multimedia file according to a generation time formation based file name request; and
a file name output unit to display the generation time information based file name converted by the file name converter.

21. The apparatus of claim 20, wherein the file name converter comprises:
an original file list generator to generate a list of original files including generation time information of the at least one multimedia file stored in the storage medium; and
an original file rearrangement list generator to generate a rearranged list of the original files based on the generation time information of the at least one multimedia file.

22. The apparatus of claim 21, wherein the original file rearrangement list generator generates a rearranged list by analyzing a directory storing the original files.

23. A non-transitory computer readable medium to perform a method of converting a multimedia file name, the method comprising:
listing original files comprising generation time information of at least one multimedia file stored in a storage medium if a generation time information based file name conversion request for the at least one multimedia file stored in a storage medium is received;
analyzing a directory which stores the listed original files to rearrange the original files based on the generation time information of the at least one multimedia file; and
converting file names of the rearranged original files into generation time information based-file names.
